(19) United States
(12) Patent Application Publication
(10) Pub. No.: US 2004/0262454 A1
(43) Pub. Date: Dec. 30, 2004

(54) Rack drive mechanism for opening and closing an aircraft passenger door

(76) Inventors: Tobias Lehmbecker, Nottensdorf (DE); Carsten Paul, Garstedt (DE)

Correspondence Address: FASSE PATENT ATTORNEYS, P.A., P.O. BOX 726, HAMPDEN, ME, 04444-0726, US

(21) Appl. No.: 10/871,547

(22) Filed: Jun. 18, 2004

(30) Foreign Application Priority Data
Jun. 18, 2003 (DE) 103 27 404.9

(51) Int. Cl. B64C 1/14

(52) U.S. Cl. 244/129.5

(57) ABSTRACT

An aircraft passenger door is opened and closed by at least one door operating mechanism including a drive motor and a transmission unit that is rotatably arranged on the motor shaft and engages a toothed rack. The transmission unit includes first and second actuator gears respectively connected by first and second transmission shafts to first and second driven gears that are driven, preferably in opposite rotation directions, by a motor gear on the motor shaft. Thereby, the motor drives the actuator gears in opposite directions. The actuator gears engage the rack from opposite sides, with the rack extending between the actuator gears. Preferably, two racks are provided along the two side edges of the doorway opening, and four operating mechanisms are arranged in the door (two at each side edge thereof).

### PRIORITY CLAIM

This application is based on and claims the priority under 35 U.S.C. §119 of German Patent Application 103 27 404.9, filed on Jun. 18, 2003, the entire disclosure of which is incorporated herein by reference.

### FIELD OF THE INVENTION

The invention relates to an apparatus that includes a toothed rack cooperating with an actuator gear wheel for opening and closing an aircraft passenger door. The door arrangement and the apparatus are especially of the type in which the door is opened by tilting the door inwardly about its bottom door edge and is then moved upwardly and positioned in the opened state, preferably in a space between the airframe structure of the aircraft fuselage and the interior trim of the aircraft cabin.

For closing the door, this motion sequence is reversed.

### BACKGROUND INFORMATION

Conventional systems for opening and closing a passenger door of an aircraft have typically been constructed and operated according to one of two distinct general principles.

According to the first general principle, the door is opened by moving it inwardly and upwardly into the aircraft. Thus, in the closed condition, the door is pressed outwardly against the doorway opening, e.g. the fuselage frame around the doorway opening. The door thus acts as a plug for the doorway opening, such that the door is seated tightly into the doorway opening by the prevailing pressure difference when the cabin interior is pressurized and the outside ambient environment is at a reduced pressure at flight altitude. In order to open the door, the pressure difference must first be eliminated or minimized. Then, the door is tilted inwardly about its bottom door edge and thereafter moved upwardly and positioned in its open state, preferably in a space between the aircraft fuselage structure and the interior trim of the aircraft cabin. The closing of the door is carried out by reversing the above sequence of processes. This general first principle for opening and closing an aircraft passenger door can be particularly carried out according to any one of three embodiments.

In a first embodiment of the first principle, a centrally arranged motor serves to rotate or turn a lever mechanism in order to start the door-opening process, such that the passenger door can be tilted inwardly about the bottom edge of the door. Thereby, a toothed gear rack comes into contact with driven gear wheels that engage and drive the toothed rack and thereby move the door upwardly. Meanwhile, the door is additionally guided by glide shoes or slides that engage into a corresponding groove in the toothed rack. Disadvantageously, these glide shoes or slides can become tilted and thus jammed, especially in an emergency situation, and thereby can hinder or prevent the proper opening motion of the door. Furthermore, in the event of a fault, malfunction or failure of the motor, there would be a total failure of the entire operation of the door, unless plural redundant motors are provided.

According to a second embodiment of the first general principle, the motion sequence for opening the door is actuated and controlled by a cable tackle arrangement, while glide shoes or rollers further assist the guidance of the door. In this embodiment as well, the glide shoes or rollers can become tilted and jammed as discussed above, and additionally the cable requires very good maintenance in order to avoid an eventual fraying and breaking of the cable. Moreover, in this embodiment as in the previously described embodiment, a motor failure would lead to a total failure of the operation of the door.

A third embodiment of the first general principle involves an elastic band connected along the upper aircraft fuselage contour, for moving the door upwardly. The elastic band runs along parallel with and under the floor of the aircraft. The band is pre-stressed with a prescribed tension such that the elastic band will be effective to pull the door upwardly and hold the door in its upper position. In such a system, it is a significant disadvantage that the elastic band must be replaced frequently in order to ensure a smooth and rapid opening of the passenger door.

The second general principle for opening and closing a passenger door involves opening the door by moving it outwardly out of the doorway opening. Thus, the door opens in the direction of the pressure difference between the pressurized cabin interior and the reduced pressure in the outside ambient environment at flight altitude. For this reason, the door must be strongly and reliably secured against the pressure difference, which is achieved by so-called door stoppers. In order to open the door, first a locking and/or latching mechanism, which may also trigger and release an emergency slide in the event of an emergency situation, is unlocked or unlatched at the bottom of the door. Then, to release the passenger door from the door stoppers, the door is lifted upwardly so that then the door can be moved outwardly over the door stoppers. The guidance of the passenger door in its outward motion is carried out by a support arm and by a parallelogram guide rod arrangement at the top edge of the door. When swinging open the door toward the outside, the outer surface of the door always remains oriented or facing outwardly. This involves a rather complex motion guided by the above mentioned arrangements, and driven by a plurality of actuator motors in an automatic manner.

In this regard, it is disadvantageous that the carrier arm significantly increases the total weight of the passenger door arrangement, and the parallelogram guide rod arrangement has a relatively complex construction that is subject to problems and interference, and requires regular inspection and maintenance. Moreover, because the door opens outwardly, the external equipment adjacent to the aircraft must be correspondingly constructed, for example the upper platform of a mobile passenger stairway or of a jetway must be appropriately dimensioned and located so that the door can open clear of any obstruction. Also, the external equipment must be suitably dimensioned so that the door can also be manually opened in the case of an emergency situation. Furthermore, the entire motion sequence of the opening door must be designed with consideration of all possible environmental influences, especially including the weather. For example, the door construction must be able to withstand wind speeds up to wind force 10 during the opening process and in the open state, and the entire door casing or trim must be able to withstand exposure to snow and rain and the like.

### SUMMARY OF THE INVENTION

In view of the above, it is an object of the invention to provide a door opening and closing mechanism of the above descried general type, using at least one toothed rack with a cooperating actuator gear, and entirely without any lever mechanism that would be subject to interference and failure. The invention further aims to avoid or overcome the disadvantages of the prior art, and to achieve additional advantages, as apparent from the present specification. The attainment of these objects is, however, not a required limitation of the present invention.

The above objects have been achieved according to the invention in a passenger door arrangement of an aircraft including a door that is movably arranged so as to selectively open or close a doorway opening of the aircraft. The door is opened by tilting it inwardly about its bottom edge and then moving it upwardly, for example preferably into a space between the aircraft fuselage airframe structure and the interior trim of the aircraft cabin. The door is closed by reversing this motion sequence. The door arrangement includes a toothed gear rack and a door operating mechanism that comprises a drive motor and a transmission unit interposed for operative power transmission between the motor and the toothed gear rack.

The transmission unit comprises a gear train including a motor gear and first and second transmission gears or driven gears. The motor gear is fixed on a motor shaft of the motor, such that the motor gear rotates with the motor shaft driven by the motor. The first and second driven gears are driven directly or indirectly by the motor gear. The gear train further comprises first and second actuator gears that are respectively connected to and driven by the first and second driven gears. The transmission unit is rotatably supported on the motor shaft of the motor. For example, the transmission unit is supported on the motor shaft via rotation bearings or the like, in such a manner that the motor shaft can freely rotate relative to the transmission unit, and the transmission unit can freely pivot about the motor shaft.

The first and second actuator gears respectively engage the associated toothed gear rims, i.e. the gear cogs, of the toothed rack. In other words, the toothed rack runs between the two actuator gears, and the actuator gears respectively engage toothed gear rims on opposite sides of the toothed rack. Thus, when the actuator gears are driven by the motor through the gear train, the actuator gears will drive and move the toothed rack relative to the transmission unit, i.e. will move the transmission unit relatively along the toothed rack. To achieve this, the two actuator gears are driven in respective opposite rotation directions through the gear train of the transmission unit, since the actuator gears respectively engage the toothed rack from opposite sides. Also, the pivotability of the transmission unit on the motor shaft allows a trouble-free engagement of the actuator gears with the toothed rack, while allowing the tilting of the door during the opening and closing processes, and while allowing essentially any required (e.g. non-linear curved or angled) shape of the toothed rack that defines the opening and closing motion path of the door.

In a first preferred embodiment, the drive motor is mounted in the door and the associated transmission unit is arranged at a side edge of the door, while the toothed rack is mounted along a side edge of the doorway opening. i.e. on an airframe doorway surround structure or doorway frame of the fuselage. In an alternative second embodiment, the toothed rack is mounted along the side edge of the door, while the drive motor and the transmission unit are mounted in/on the airframe doorway surround structure beside the doorway opening.

Preferably, a respective toothed rack is provided at both sides of the door, i.e. along the left side and along the right side. Correspondingly, at least one respective drive motor and transmission unit are arranged on the left side and on the right side of the door. Preferably, there is one rack on each side of the door, and two motors and transmission units on each side of the door, i.e. a total of two racks and four motors and four transmission units, included in the overall door arrangement.

In a preferred embodiment, the transmission unit further comprises two frame plates or brackets that are spaced apart and extend parallel relative to each other, while being rotatably supported on the motor shaft of the motor. In other words, these frame plates can remain still or can pivot while the motor shaft freely rotates or remains still. For this purpose, the frame plates are supported on the motor shaft via rotation bearings such as roller bearings (e.g. ball bearings or needle bearings) or glide bearings (e.g. sleeve bearings). The first and second transmission shafts are each rotatably supported in each of the two frame plates and extend between and/or through the two frame plates, whereby the frame plates are connected with each other. An end of each transmission shaft protrudes beyond one of the frame plates, and a respective one of the first and second actuator gears is fixedly mounted on this protruding end of the transmission shaft, respectively. Furthermore, the two driven gears and the motor gear are rotatably received between the two frame plates. The two driven gears are respectively fixedly mounted on the two transmission shafts. In this manner, the two actuator gears are respectively connected to and driven by the two driven gears via the two transmission shafts.

Furthermore, one of the two driven gears directly engages the motor gear, while an additional reversing gear is rotatably supported between the two frame plates of the transmission unit and is interposed and engaged between the other one of the driven gears and the motor gear. Thereby, the two driven gears will rotate in opposite rotation directions, and correspondingly the two actuator gears will rotate in opposite rotation directions, based on a single rotation direction of the motor gear, i.e. of the motor and its motor shaft. In different embodiments, either one of the two driven gears may be directly driven by the motor gear while the other one of the two driven gears is driven through the reversing gear.

According to another feature of the invention, the door operating mechanism and preferably the transmission unit further comprises a manually operable crank drive engaging the gear train, whereby the door can be opened manually by operating a hand crank in the event of a failure of the motors or other emergency situation.

In comparison to the above described conventional door operating arrangements including a parallel guide rod or support arm construction, the present inventive arrangement achieves a significant weight reduction by omitting a plurality of independent actuator motors with respective different functions and by reducing the static load demands on the door construction, which may thus be made simpler and lighter. Furthermore, the door opens inwardly into the aircraft, so that the construction can be simpler without requiring door stoppers and the like, and also, the door does not need to be constructed so as to withstand environmental influences (such as rain and the like) when the aircraft is parked at an airport with the door open.

In comparison to conventional arrangements of a passenger door that opens inwardly and upwardly into an aircraft, the inventive arrangement provides an advantage in that the previously utilized or existing fuselage structure in the area above the doorway opening can substantially be taken over and used also for the inventive door arrangement. In other words, no substantial design changes are needed to accommodate the inventive door arrangement in existing aircraft fuselage designs. Furthermore, the inventive door arrangement can be easily retrofitted into existing aircraft. The existing doorway opening periphery or doorway surround structure does not need to be replaced, reinforced, or otherwise significantly altered. Furthermore, the inventive door arrangement uses simple time-tested technology and components, which require a reduced maintenance and inspection in comparison to conventional arrangements.

### BRIEF DESCRIPTION OF THE DRAWINGS

In order that the invention may be clearly understood, it will now be described in connection with example embodiments thereof, with reference to the accompanying drawings, wherein:

FIG. 1 is a schematic top view illustration of a door operating mechanism according to the invention, including an electric drive motor and a transmission unit that is arranged on a motor shaft of the motor and that engages a toothed rack;

FIG. 2 is an end view of the transmission unit of FIG. 1, especially showing the two actuator gears thereof, with the toothed rack therebetween;

FIG. 3A is a sectional view through the transmission unit along the section line III-III in FIG. 1;

FIG. 3B is a schematic illustration similar to FIG. 3A, but shown as an end view rather than a sectional view, and additionally indicating the rotation direction of the several gears;

FIG. 4 is a side view of an aircraft passenger door schematically indicating the locations and arrangement of four door operating mechanisms according to the invention; and

FIG. 5 is an enlarged top sectional view of a portion of FIG. 4, showing one electric drive motor arranged in the door and the associated transmission unit at the door edge engaging a toothed rack mounted on the doorway surround structure of the fuselage.

### DETAILED DESCRIPTION OF A PREFERRED EXAMPLE EMBODIMENT AND OF THE BEST MODE OF THE INVENTION

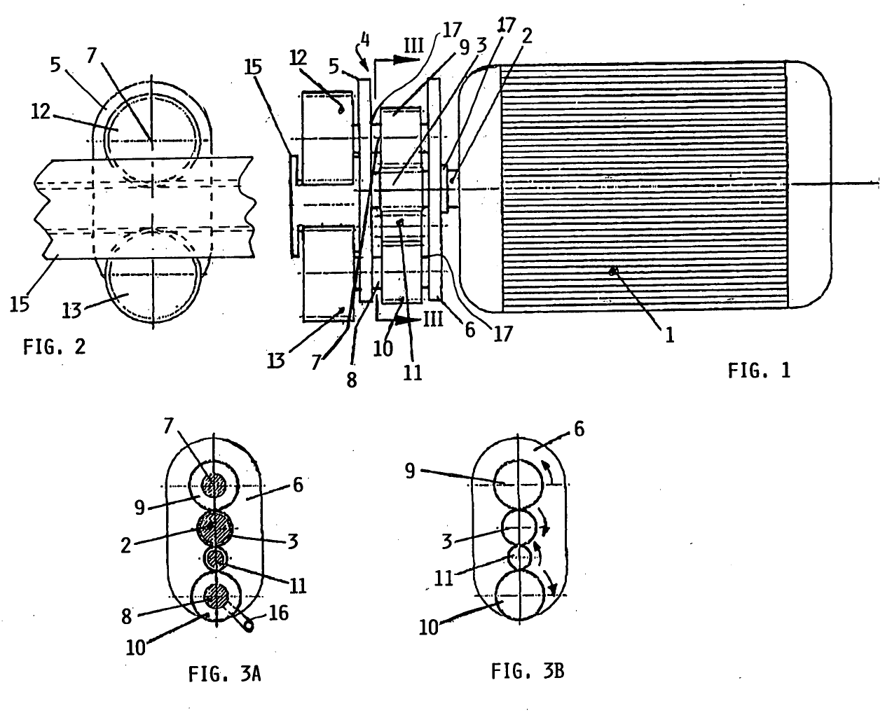

FIG. 1 schematically shows a door operating mechanism for opening and closing a passenger door of an aircraft. The mechanism includes an electric drive motor 1 (alternatively a hydraulic or pneumatic motor) and a transmission unit 4, and cooperates with a toothed rack 15. The drive motor 1 includes and rotationally drives a motor shaft 2, which has a motor gear 3 mechanically fixedly mounted there, for example by means of a tongue and groove joint, e.g. a splined shaft end or a key and keyway combination, or the like. Furthermore, the transmission unit 4 is arranged and supported on the motor shaft 2 in such a manner that the motor shaft 2 can freely rotate relative to the transmission unit 4 and the transmission unit 4 is free to pivot on the motor shaft 2. For example, the transmission unit 4 is mounted on the motor shaft 2 by a suitable rotational bearing 17 such as a roller bearing or sleeve bearing.

More particularly, the transmission unit 4 comprises two frame plates or brackets 5 and 6 that extend parallel to each other and are spaced apart from each other at a prescribed distance. These two frame plates 5 and 6 are each rotatably supported on the motor shaft 2, while receiving the motor gear 3 in the space therebetween. The transmission unit 4 further includes two transmission shafts 7 and 8 that are rotatably supported by the frame plates 5 and 6, e.g. via bearings 17 such as roller bearings or sleeve bearings, to thereby connect together the two frame plates 5 and 6. First and second driven gears 9 and 10 are respectively mechanically fixedly mounted on the first and second transmission shafts 7 and 8 in the space between the two frame plates 5 and 6. The gear train of the transmission unit 4 including the driven gears 9 and 10 further includes a reversing gear 11 that is rotatably supported between the two frame plates 5 and 6 and interposed and engaged between the motor gear 3 and the second driven gear 10. The first driven gear 9 directly engages the motor gear 3. In this manner, the first driven gear 9 is driven directly by the motor gear 3 in a rotation direction opposite that of the motor gear 3, while the second driven gear is driven via the reversing gear 11 in a rotation direction corresponding to that of the motor gear 3 (see FIG. 3B).

The transmission shafts 7 and 8 protrude outwardly beyond and away from the frame plate 5 on the side opposite the motor 1, and have respective first and second actuator gears 12 and 13 mechanically fixedly secured on the protruding shaft ends of these first and second transmission shafts 7 and 8. The first and second actuator gears 12 and 13 respectively engage the gear teeth on opposite sides of the toothed gear rack 15, which runs between the two actuator gears 12 and 13 (see FIGS. 1 and 2).

The above described features can be clearly seen and understood in the top view of FIG. 1, in connection with the end view of FIG. 2 and the sectional views of FIGS. 3A and 3B. Note the rotation directions of the various gears 3, 9, 10 and 11 as indicated by corresponding arrows in FIG. 3B. The respective rotation directions will all be reversed by reversing the rotation of the electric drive motor 1, e.g. for selectively opening or closing the door. Also, the relative dimensions and arrangement of the several gears and other components such as the frame plates 5 and 6 of the transmission unit 4 can be clearly seen in FIGS. 1, 2, 3A and 3B.

As schematically indicated in FIG. 3A, the door operating mechanism may further include a manually operable crank 16 that allows the gear train to be driven by hand, in order to open the door in the event of an emergency situation, e.g. a failure of the motor 1, or a power failure of the electric power supply, or the like. This manually operable crank 16 may, for example, be removably connected to the gear train of the transmission unit 4, to be installed and used only in an emergency situation. FIG. 3A merely schematically indicates the manually operable crank 16, whereas the actual structural arrangement thereof could take various forms as would be evident to the skilled artisan. For example, one of the gears, such as the second driven gear 10, could have radial holes at spaced locations around the circumference thereof (e.g. in the gear face thereof), allowing a manually operable crank lever or other tool to be inserted successively into the radial holes for turning the gear step-by-step in angular amounts corresponding to the hole spacing. Alternatively, the crank 16 could be engaged axially into the end of the transmission shaft 8 for rotating this shaft 8, provided that there is sufficient clearance for rotating the crank handle.

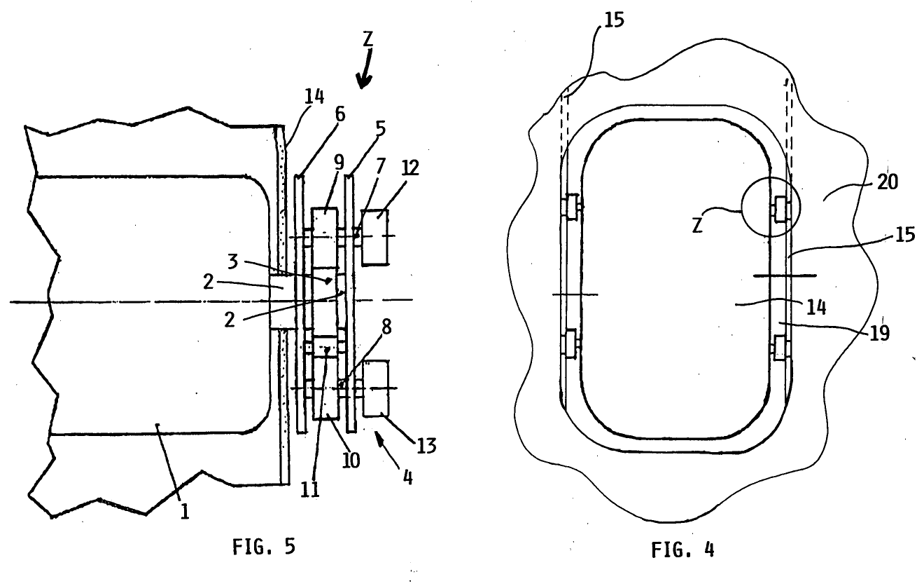

As will be described further below, the respective toothed rack 15 is preferably secured onto one of the two sides of the doorway surround structure 20 including doorway frames of the fuselage bounding the doorway opening 19 (see FIG. 4). In this context, it should be understood that a respective one of the toothed gear racks 15 is provided on each side of the door 14, and correspondingly one or two of the door operating mechanisms Z are mounted in the door 14 adjacent to each side edge thereof (see FIG. 4). Alternatively, the toothed gear racks can be fixed on the sides of the door itself, while the door operating mechanisms are mounted in the doorway surround structure of the fuselage. Preferably, the toothed gear racks are shaped or contoured in such a manner so that they properly define the tilting and upward motion path of the door 14 during its opening procedure. This is accommodated without problems, especially by the freely tiltable or pivotable arrangement of the transmission units 4 on the respective motor shafts 2.

As already discussed, the motion path of the passenger door 14 is inward and upward relative to the door opening in the aircraft fuselage. For this opening process, the door is first unlatched and then tilted inwardly about the door's bottom edge, then driven upwardly through the actuation of the inventive door operating mechanism, and then positioned in its open condition above the doorway, preferably in a space between the structural airframe of the aircraft fuselage and the internal trim paneling and the like of the cabin interior. The particular motion path of the passenger door 14 on the door frames is defined by the shape and arrangement of the toothed gear racks 15 and is accommodated by the tiltability of the transmission units 4 as discussed above.

In a preferred embodiment as schematically shown in FIGS. 4 and 5, four of the door operating mechanisms Z according to the invention are provided for opening and closing the passenger door 14 relative to the doorway opening 19 in the fuselage doorway surround structure 20 of the aircraft fuselage. This arrangement provides a balanced, distributed and jam-free drive power distribution for a smooth opening and closing operation of the door. This arrangement also fully supports and guides the door 14 along the opening and closing motion path defined by the toothed racks 15, without requiring any additional arms, levers, guide members or the like for supporting or guiding the door. In this regard, note that the toothed racks 15 extend above the doorway along the sides of the door, upwardly into the final open position of the door, e.g. in a pocket or opening in the fuselage or interior trim construction above the doorway. Also, in the event of the failure of one or even two of the motors or operating mechanisms, the door can still be operated with the remaining two or three motors and mechanisms.

A representative one of the door operating mechanisms Z is shown in an enlarged detail partial view in FIG. 5, showing the area of the mechanism Z indicated in FIG. 4. This door operating mechanism Z corresponds to that described above in connection with FIGS. 1, 2, 3A and 3B. Here, the electric drive motor 1 is arranged within the door 14, while the transmission unit 4 is adjacently positioned along the side edge of the door 14 (where it may be covered with suitable trim components for visual and safety reasons). In this arrangement, two of the door operating mechanisms Z respectively cooperate with each one of the two toothed gear racks 15 that are fixedly secured respectively along the two sides of the doorway opening, i.e. on the doorway frames of the doorway surround structure 20 bounding the doorway opening 19.

The above described freely rotatable or pivotable support of the transmission unit 4 on the motor shaft 2 of the motor 1 makes it possible to provide a great variety or flexibility in the design of the motion path of the door, able to accommodate essentially any desired or required door motion path curves, angles or deflections. Furthermore, this arrangement makes it easily possible for each respective transmission unit 4 to engage from both sides into the respective gear teeth of the associated toothed gear rack 15 with the actuator gears 12 and 13.

The door arrangement requires no further locking or latching means for holding the door in the open position. Instead, the door 14 will be held and remain in the open position by the inherent friction or rotation resistance of the several components and especially the electric motor of each door operating mechanism, and/or will be held in the closed position by its own weight.

Although the invention has been described with reference to specific example embodiments, it will be appreciated that it is intended to cover all modifications and equivalents within the scope of the appended claims. It should also be understood that the present disclosure includes all possible combinations of any individual features recited in any of the appended claims.

What is claimed is:

1. An apparatus for opening and closing an aircraft passenger door comprising:
at least one toothed rack; and
at least one door operating mechanism that engages and cooperates with said toothed rack to drive said toothed rack and said door operating mechanism relative to each other so as to open and close the aircraft passenger door;
wherein said door operating mechanism comprises:
a motor including a rotationally drivable motor shaft; and
a transmission unit, which is rotatably supported on said motor shaft, and which includes a motor gear fixed onto said motor shaft, first and second driven gears that are driven directly or indirectly by said motor gear, and first and second actuator gears that are respectively connected to and driven by said first and second driven gears and are arranged to be able to engage said toothed rack.

2. The apparatus according to claim 1, wherein said transmission unit further includes a reversing gear interposed and engaged between said second driven gear and said motor gear, and wherein said first driven gear is engaged directly with and driven directly by said motor gear, whereby said first and second driven gears and said motor gear are linked with one another such that said first driven gear and said first actuator gear will rotate in a first rotation direction opposite said motor gear and said second driven gear and said second actuator gear will rotate in a second rotation direction corresponding with said motor gear.

3. The apparatus according to claim 2, wherein said transmission unit is arranged relative to said toothed rack so that said first and second actuator gears respectively simultaneously engage opposite first and second toothed sides of said toothed rack, with said toothed rack extending between said first and second actuator gears.

4. The apparatus according to claim 1, wherein said transmission unit further comprises rotational bearings by which said transmission unit is rotatably supported on said motor shaft, and said transmission unit is not otherwise supported other than by said rotational bearings.

5. The apparatus according to claim 1, wherein said toothed rack has a non-linear extending shape including at least one of a curve and a bend, and wherein said non-linear extending shape of said toothed rack defines a motion path of said door during the opening and closing of said door.

6. The apparatus according to claim 1, wherein said transmission unit further includes:
two frame plates that are spaced apart from each other, rotatably receive said first and second driven gears and said motor gear in a space therebetween, and are each rotatably supported on said motor shaft; and
first and second transmission shafts that are each rotatably supported by said two frame plates, and are each respectively fixed to a respective one of said first and second actuator gears located outside of said space and a respective one of said first and second driven gears located in said space.

7. The apparatus according to claim 6, further comprising rotational glide bearings arranged in and/or on said two frame plates and rotatably supporting said first and second transmission shafts relative to said frame plates.

8. The apparatus according to claim 6, further comprising roller bearings arranged in and/or on said two frame plates and rotatably supporting said first and second transmission shafts relative to said frame plates.

9. The apparatus according to claim 1, wherein said transmission unit further comprises a manually operable crank linked to said gears so that said gears can be manually rotated using said crank in an emergency or malfunction situation.

10. The apparatus according to claim 1, wherein said transmission unit and said drive motor provide sufficient friction and/or resistance to rotation of said gears, so that the door is maintained in an open end position by said friction and/or resistance to rotation without any latch for this purpose.

11. The apparatus according to claim 1, wherein
said at least one toothed rack includes left and right toothed racks respectively arranged at left and right upright edges of the door;
said at least one door operating mechanism includes at least one left one of said door operating mechanisms arranged at said left upright edge of the door and cooperating with said left toothed rack and at least one right one of said door operating mechanisms arranged at said right upright edge of the door and cooperating with said right toothed rack.

12. The apparatus according to claim 11, wherein said at least one left door operating mechanism includes a total of two of said left door operating mechanisms, and said at least one right door operating mechanism includes a total of two of said right door operating mechanisms.

13. The apparatus according to claim 11, wherein said left and right door operating mechanisms are respectively mounted in and/or on the door at the left and right upright edges thereof, and said left and right toothed racks are respectively secured on an aircraft fuselage doorway surround structure respectively adjoining the left and right upright edges of the door.

14. The apparatus according to claim 11, wherein said left and right toothed racks are respectively secured to the door along the left and right upright edges thereof, and said left and right door operating mechanisms are respectively mounted in and/or on an aircraft fuselage doorway surround structure respectively adjoining the left and right upright edges of the door.

15. The apparatus according to claim 1, excluding all levers, rods and arms for supporting, guiding, or moving the door.

16. In a passenger aircraft including a fuselage with a doorway surround structure surrounding a doorway opening, a passenger door arranged to selectively close and open said doorway opening, and an apparatus for opening and closing said door, wherein opening said door involves tilting said door inwardly into said aircraft about a bottom edge of said door and then moving said door upwardly into an open position above said doorway opening, and closing said door involves moving said door downwardly from said open position to said doorway opening and then tilting said door outwardly into said doorway opening,
an improvement in said apparatus for opening and closing said door, comprising:
left and right toothed racks that are respectively arranged at left and right upright edges of said door; and
left and right door operating mechanisms that are respectively arranged at said left and right upright edges of said door, and that respectively engage and cooperate with said left and right toothed racks to drive said toothed racks and said door operating mechanisms relative to each other so as to effectuate said opening and closing of said door;
wherein each one of said door operating mechanisms respectively comprises:
a motor including a rotationally drivable motor shaft; and
a transmission unit, which is rotatably supported on said motor shaft and is thereby pivotable relative to said motor, and which includes a motor gear fixed onto said motor shaft, first and second driven gears that are driven directly or indirectly by said motor gear, and first and second actuator gears that are respectively connected to and driven by said first and second driven gears and are arranged to be able to engage one of said toothed racks.

17. The improvement in the apparatus in the aircraft according to claim 16, wherein said left and right toothed racks include a single left toothed rack and a single right toothed rack and said left and right door operating mechanisms include two left door operating mechanisms that engage and cooperate with said left toothed rack and two right door operating mechanisms that engage and cooperate with said right toothed rack.

18. The apparatus according to claim 16, wherein said left and right door operating mechanisms are respectively mounted in and/or on said door at said left and right upright edges thereof, and said left and right toothed racks are respectively secured on said doorway surround structure respectively adjoining said left and right upright edges of said door.

19. The apparatus according to claim 16, wherein said left and right toothed racks are respectively secured to said door along said left and right upright edges thereof, and said left and right door operating mechanisms are respectively mounted in and/or on said doorway surround structure respectively adjoining said left and right upright edges of said door.

20. The apparatus according to claim 16, excluding all levers, rods and arms for supporting, guiding, or moving said door.
